(19) United States
(12) Patent Application Publication
(10) Pub. No.: US 2009/0232576 A1
(43) Pub. Date: Sep. 17, 2009

(54) Printer

(76) Inventor: Takuro Kohyama, Tokyo (JP)

Correspondence Address: SMITH, GAMBRELL & RUSSELL, 1130 CONNECTICUT AVENUE, N.W., SUITE 1130, WASHINGTON, DC, 20036, US

(21) Appl. No.: 11/887,002

(22) PCT Filed: Oct. 5, 2006
(86) PCT No.: PCT/JP2006/319971

§ 371 Date: Sep. 24, 2007

(30) Foreign Application Priority Data
Oct. 27, 2005 (JP) 2005-313033

(51) Int. Cl. B41J 11/00

(52) U.S. Cl. 400/621

(57) ABSTRACT

A portion of a paper guide member (5) formed of single thin elongated plate bent at two or three places in the middle section thereof is inserted into a gap in a joint between two components (4, 2) located upstream and downstream along a paper path, formed in the vicinity of a paper discharging slot (3) of a printer, and another portion of the paper guide member (5) is left in the paper path. The portion left in the paper path is held in a position protruding into the paper path with respect to the downstream component (2) so as to guide the recording paper to be ejected toward the paper discharging slot (3).

### TECHNICAL FIELD

The present invention relates to a printer having a paper path formed by joining a plurality of components, and in particular relates to a printer configured so as to avoid the occurrence of a paper jam by preventing the leading end of recording paper from entering a gap in a joint between the paper path components.

### BACKGROUND ART

Shops, stores, and the like are traditionally required to give each customer a sheet of paper as a receipt with the date and time of the sale, the names and prices of the goods sold, and other related information printed thereon, while retaining a copy for sales management and inventory control. Printers for such purposes were filed in the Japanese Patent Office and laid open as JP 2005-343649 A, on Dec. 15, 2005, and JP 2006-008256 A, on Jan. 12, 2006.

The printers proposed in the above patent documents will be schematically described below with reference to FIGS. 3 to 5.

The printer 10 shown in FIG. 3 includes a printer body 11 in which an ink ribbon cassette (not shown) is detachably mountable, a printing mechanism causing a carriage carrying a printing head 12 positioned at an end of the ink ribbon cassette to reciprocate in the widthwise direction of recording paper 13 serving as a recording medium, a paper feeding mechanism driven by a recording paper feeding motor 16 to feed two-ply sheets of the recording paper 13 rolled around a roll shaft 14 while pressing them against the printing position of the printing head, an automatic cutter 15 disposed above the paper feeding mechanism to cut the sheet of recording paper 13 to be handed to the customer, and a recording paper take-up device 18 disposed at the rear of the printer body 11 and driven by a recording paper take-up motor 17 to take up the other sheet of the recording paper 13, which is kept at the store.

The operation of the printer 10 will be described below. The recording paper 13 is formed as a roll of two-ply thermal recording paper of a predetermined width rolled around the roll shaft 14. The two-ply paper includes a sheet to be handed to the customer as a receipt and another sheet to be kept at the store. When the roll shaft 14 is driven by the recording paper feeding motor 16 and turns in the direction of arrow A, the recording paper 13 is fed in the direction of arrow B. In FIG. 3, the paper path 19 is indicated by a dotted line.

The recording paper 13 is then guided by a paper feed guide 20 and further directed by a paper feed roller 21 connected to the recording paper feeding motor 16 to the printing position.

When the recording paper 13 reaches the printing position along the paper path 19, the printing mechanism, including the printing head 12, prints predetermined information including the time and date of a sale, names and prices of the goods sold, and names of the shop and cashier on the recording paper 13. Then, the sheet of recording paper 13 to be handed to the customer is ejected in the direction indicated by arrow C through a paper discharging slot 3 provided in the upper surface 2a of the outer case 2. This sheet of recording paper 13 is then cut by the automatic cutter 15 and handed to the customer.

The sheet of recording paper 13 to be kept at the store is transferred in the direction of arrow E and taken up by a take-up shaft 25 turning in the direction of arrow D actuated by a train of gears 24 turned by the recording paper take-up motor 17.

As described above, the paper discharging slot 3 for ejecting the sheet of recording paper 13 is located in the upper surface 2a of the outer case 2. In the vicinity of the paper discharging slot 3, the automatic cutter 15, which is an upstream component on the paper path, is joined to the outer case 2, which is a downstream component on the paper path. Between the joined components, there may be a gap G, as shown in FIG. 4, due to variations in the dimensional accuracy of these components and their assembled positions.

Normally, the sheet of recording paper 13 to be handed to the customer is ejected in the direction indicated by arrow C along the double-dot-dashed line in FIG. 5, through the paper discharging slot 3 provided in the upper surface 2a of the outer case 2. If the leading end of this sheet happens to be curled or buckled, however, it may occasionally enter the gap G (see FIG. 4) between the joined paper path components in the direction indicated by arrow F and cause a paper jam (i.e., paper clogging inside the printer). A paper jam is troublesome; it prevents the recording paper 13 from being fed for printing. In this case, the jammed recording paper 13 must be removed by opening the cover of the outer case 2.

### DISCLOSURE OF INVENTION

It is an object of the present invention to provide a printer that can avoid the occurrence of a paper jam by preventing the leading end of a sheet of recording paper from being caught by or introduced between upstream-side and downstream-side components in a paper path if there is a gap between these two components that was assembled under certain restrictions that enforce the use of existing structural parts, for example.

To achieve the above object, the printer according to the present invention comprises a paper path formed by a plurality of components joined to each other for transferring the recording paper, and a paper guide member formed of a single thin elongated plate that is bent at at least one place in its middle section. A portion of the paper guide member is inserted between a first and second components of the plurality of components forming the paper path, arranged on the upstream and downstream sides of the paper path, respectively, through the gap in a joint between the first and second components, while the remaining portion of the paper guide member, which is left in the paper path, holds a posture that protrudes into the paper path with respect to the second component.

The portion of the paper guide member that has been inserted between the first and second paper path components may be fixed to or engaged with the first or second component.

The paper guide member may be made of a plastic sheet.

The first component may be an automatic cutter for cutting the recording paper sheet passing through the paper path, while the second component may be an outer case.

As the printer according to the present invention is configured as described above, it can prevent a paper jam even if there is a gap between the components defining a paper path, assembled under certain restrictions that enforce the use of existing structural parts, for example, since a portion of a simply-shaped paper guide member, which is formed of a bent thin plate, is inserted into the gap and the remaining portion of the paper guide member is left in the paper path, with the result that the leading end of a recording paper sheet moving along the paper path toward the paper discharging slot cannot be caught by the gap or cannot be introduced into the gap.

This paper guide member can be attached to the printer easily by simply inserting a portion of the paper guide member between two components defining the paper path and fixing it to or engaging it with either one of these components. The paper guide member thus attached can hold itself in a stable position capable of guiding the recording paper sheet running through the paper path toward the paper discharging slot.

The paper guide member can be made of plastic sheet material, which is inexpensive and can easily be bent at an acute angle, so that it is possible to provide a printer excellent in reliability.

### BRIEF DESCRIPTION OF DRAWINGS

FIG. 1 is a sectional view of the structure of a printer according to an embodiment of the present invention, in the vicinity of a paper discharging slot.

FIG. 2 is a perspective view of the printer in FIG. 1, with its outer case opened.

FIG. 3 is a side view illustrating the structure of an exemplary conventional printer.

FIG. 4 is an enlarged sectional view of relevant parts of the printer in FIG. 3, in the vicinity of a paper discharging slot.

FIG. 5 illustrates a case in which the recording paper sheet is ejected normally through the paper discharging slot of the printer in FIG. 3 and a case in which the leading end of the recording paper sheet enters a gap between the joined components and causes a paper jam.

### BEST MODE FOR CARRYING OUT THE INVENTION

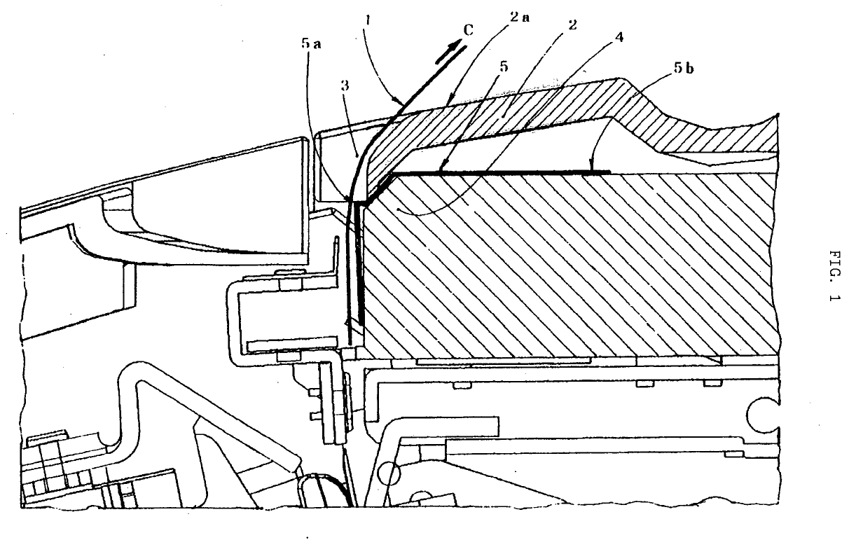

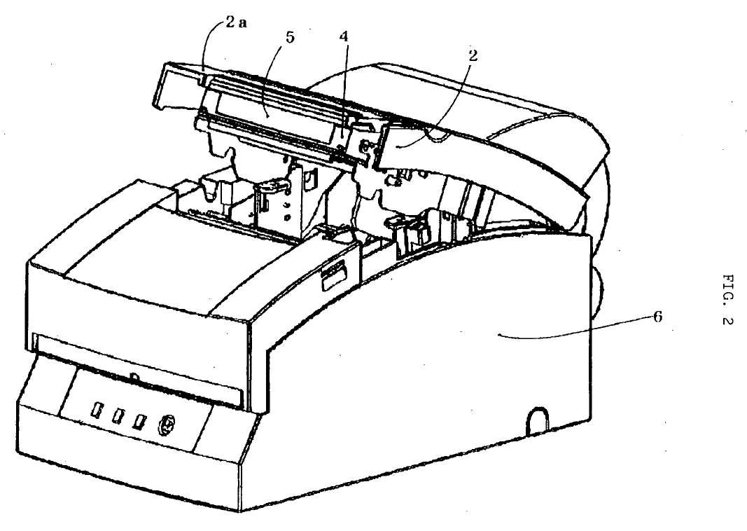

A printer according to an embodiment of the present invention will now described with reference to FIGS. 1 and 2.

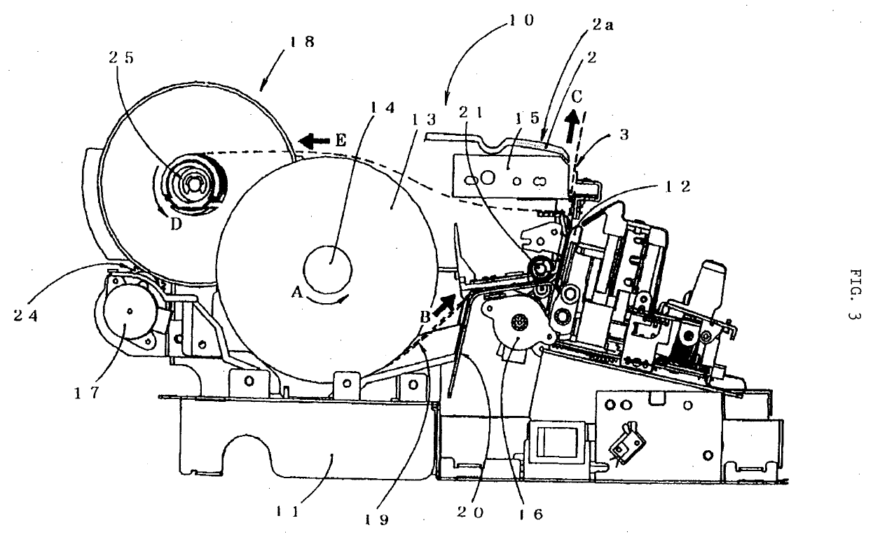

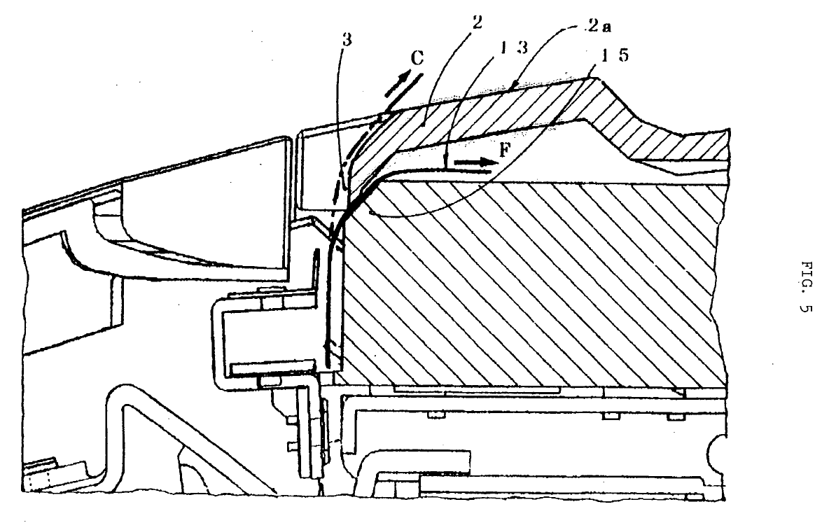

The basic structure of the printer is identical to that of the conventional printers proposed in the above patent documents and described with reference to FIGS. 3 to 5, so it will not be described below.

Of the two sheets of recording paper with predetermined items printed thereon, the sheet 1 to be given to a customer passes along a paper path and is ejected through a paper discharging slot 3 provided at an end of an upper surface of an outer case 2. In the vicinity of the paper discharging slot 3, a paper path is formed by joining an automatic cutter 4, which is a component arranged on the upstream side of the paper path, and an outer case 2, which is a component arranged on the downstream side of the paper path.

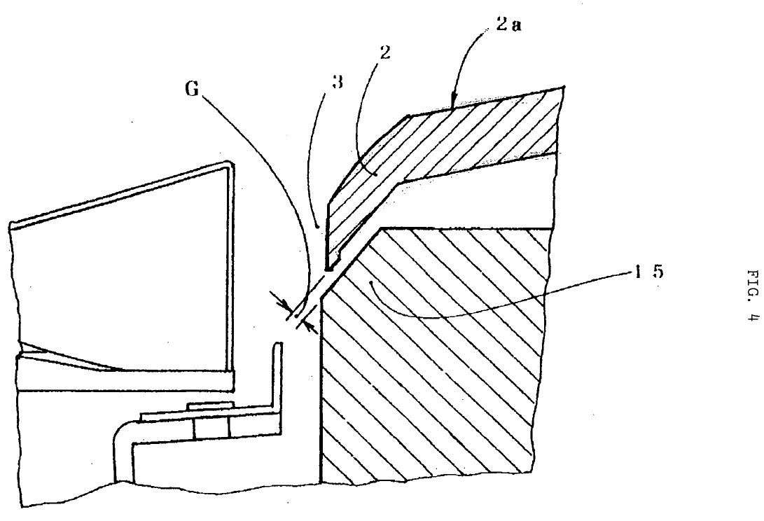

A paper guide member 5 is formed of a thin elongated plate, such as a plate of plastic sheet material, and bent at two or three places in its middle section. A part of the paper guide member 5 (forward portion ahead of a bend 5a formed at the longitudinal center of the paper guide member 5) is inserted into a gap (corresponding to the gap G in FIG. 4) between the automatic cutter 4 and the outer case 2, both of which are the components defining the paper path.

In FIG. 2, reference numeral 6 denotes the case body.

A part 5b of the portion (forward portion) of the paper guide member 5 which is inserted between the automatic cutter 4 and the outer case 2 is fixed to the upper surface of the automatic cutter 4 by double faced adhesive tape. It should be noted that fixing of the paper guide member 5 to the automatic cutter 4 is made in various ways, in addition to fixing by use of the double faced adhesive tape. The paper guide member 5 may be secured to the automatic cutter by means of screws or may be engaged with a part of the automatic cutter 4 without using any particular fastening member. Alternatively, the part 5b of the paper guide member 5 may be secured to or engaged with the lower surface of the outer case 2.

Though the forward portion of the paper guide member 5 is inserted between the automatic cutter 4 and the outer case 2, a rear portion of the paper guide member 5 in the rear of the bend 5a is left exposed in the paper path and kept in a position protruding into the paper path with respect to the outer case 2 which is a component arranged on the downstream side of the paper path.

The paper guide member 5, thus configured, serves to prevent jamming of recording paper as described below.

When the sheet 1 to be handed to the customer, of the two-ply recording paper with predetermined items printed thereon, passes along the paper path, it is guided by the bend 5a of the paper guide member 5 so as to pass over the joint between the automatic cutter 4 and the outer case 2 and advances toward the paper discharging slot 3. Accordingly, the sheet 1 is smoothly ejected in the direction of arrow C through the paper discharging slot 3 provided in the upper surface 2a of the outer case 2 without being caught by the gap (corresponding to the gap G in FIG. 4), if any, in the joint between the automatic cutter 4 and the outer case 2.

According to the present invention, the forward portion of the paper guide member 5 is inserted into the gap in the joint between the automatic cutter 4 and the outer case 2 and the part 5b thereof is fixed to the automatic cutter 4, with the result that the rearward portion of the paper guide member 5 can keep its posture constant in the paper path. The rearward portion of the paper guide member 5, left in the paper path without being inserted through the gap in the joint between the automatic cutter 4 and the outer case 2, is held in a posture protruding into the paper path with respect to the component (the outer case 2) arranged on the downstream side of the paper path, as a result, the recording paper to be discharged is guided by the paper guide member 5. Therefore, it is possible to prevent the leading end of the recording paper from entering into the gap in the joint of the components to cause a jam. The paper guide member 5 can be made of a thin plastic sheet that is inexpensive and easily workable.

As described above, the present invention can provide a reliable printer that can avoid the occurrence of a paper jam by preventing the recording paper sheet from entering the gap, if any, in the joint between two components defining a paper path that is assembled under certain restrictions that enforce the use of existing structural parts, for example.

1. A printer comprising:
a paper path for transferring recording paper, formed by a plurality of components joined to each other; and
a paper guide member formed of a single thin elongated plate which is bent at at least one place in a lengthwise middle section thereof;
wherein a portion of the paper guide member is inserted between a first and second components of said plurality of components forming the paper path, which are arranged on the upstream and downstream sides of the paper path, respectively, through a gap in a joint between said first and second components, while the remaining portion of the paper guide, which is left in the paper path without being inserted between the first and second components, is held in a posture protruding into the paper path with respect to said second component.

2. The printer according to claim 1, wherein the portion inserted between the first and second components is fixed to the first or second component.

3. The printer according to claim 1, wherein the paper guide member is formed of a plastic sheet.

4. The printer according to claim 1, wherein the first component is an automatic cutter for cutting the recording paper passing through the paper path and the second component is an outer case.
